(19) United States
(12) Patent Application Publication
(10) Pub. No.: US 2025/0217119 A1
(43) Pub. Date: Jul. 3, 2025

(54) Data Transformation Pipelines

(71) Applicant: LANXESS Deutschland GmbH, Cologne (DE)

(72) Inventors: Martin Baier, Aachen (DE); Christian Koch, Cologne (DE); Thomas Krug, Cologne (DE); Leon Ramm, Cologne (DE)

(73) Assignee: LANXESS Deutschland GmbH, Cologne (DE)

(21) Appl. No.: 18/850,427

(22) PCT Filed: Mar. 21, 2023
(86) PCT No.: PCT/EP2023/057179

§ 371 Date: Sep. 24, 2024

(30) Foreign Application Priority Data
Mar. 25, 2022 (EP) 22164345.5

(51) Int. Cl. G06F 8/40; G06F 8/30

(52) U.S. Cl. CPC G06F 8/40; G06F 8/315

(57) ABSTRACT

The present invention concerns the field of data engineering and analytics, and in particular the efficient creating and operating of data engineering workflows. A computer-implemented method is provided which comprises obtaining data defining a plurality of data transformations (200), and automatically generating a data transformation graph (100) based on the data transformations (200). Each data transformation (200) defines a step function (106) and at least one of a set of input datasets (104, 108) and a set of output datasets (108, 110), The data transformation graph (100) links the data transformations (200) by way of their input datasets (104, 108) and output datasets.

### TECHNICAL FIELD

The present invention generally concerns the field of efficient electronic data processing in the context of data engineering and analytics, and in particular techniques for efficiently creating and operating data engineering workflows.

### BACKGROUND

Data engineering and analytics includes various techniques for collecting, storing, processing, validating, analyzing and visualizing electronic data, typically very large amounts of data. Besides fundamental techniques for structuring and modeling data and the underlying relationships, data engineering also provides the technological infrastructure for efficient and scalable data processing, combining elements from disciplines such as distributed computing systems, distributed databases, query optimization and high-performance computing. The data engineering technology market is highly dynamic, driven by the shift from traditional on-premise databases to modern cloud-based data platforms built on data warehouse or data lake architectures.

Data engineering infrastructures and methods are useful in virtually any application domain in which vast amounts of data are generated and need to be processed. One example includes, without limitation, modern manufacturing facilities (“smart factories”) in which cyber-physical systems such as industrial robots operate and collaborate by exchanging data, sometimes even completely autonomously. Further exemplary application domains for data engineering techniques are the field of predictive maintenance, where data from sensors in machines are used to determine an optimal time for maintenance tasks, the field of logistics, such as for tracking the position and status of containers (e.g., from the plant to the truck, to the ship, to the train and to the customer) and for informing customers about delays, as well as the field of analysis whether products should be further processed or sold depending on the market needs.

One of the major tasks in data engineering is to transform data, e.g., by filtering and/or joining individual datasets. Data transformations can become arbitrarily complex, which makes it difficult to keep track of changes, both in terms of different versions over time and in terms of high-level activities that are taken. One example of a high-level activity is the removing of invalid entries. For the end user, it is typically only relevant that all entries are eventually valid, while it does not matter to the user which specific action have been performed, e.g., removing rows with missing values in certain columns or removing values that are semantically impossible, such as values with a timestamp in the future. Another example of a high-level activity is data anonymization, where it is important that all sensitive information is removed, but not how exactly it was removed.

Several workflow management platforms have been proposed to facilitate the handling of data transformations. One example is Apache Airflow, an open-source workflow management platform for data engineering pipelines, which uses directed acyclic graphs (DAGs) to manage workflow orchestration. Tasks and dependencies can be defined in Python and the platform manages the scheduling and execution. However, using Airflow the user needs to manually bring the steps of a workflow at least pairwise into order by defining causal relationships (in the sense of “step B follows step A”). This can make it difficult or even impossible to define a complex workflow without a priori knowledge of its overall runtime behaviour. In addition, Airflow requires a scheduler server for running a pipeline which is cumbersome and complex to set up.

Another example of a workflow management framework is Spotify Luigi, a Python module for building pipelines of batch jobs, handling dependency resolution and creating visualizations to help manage workflows. However, using Luigi, developers need to explicitly define the computing environment the workflow is supposed to be executed in, and a scheduler server is required for running a pipeline.

Palantir Foundry is another example of a workflow management platform. However, once a Transform has been developed for a certain production environment, it is very cumbersome, difficult and error-prone to adapt the Transform so that it can run in another environment, such as a local testing environment. Moreover, Foundry is currently bound to the Apache Spark ecosystem, a general-purpose cluster computing system.

US 2019/114289 A1 titled “DYNAMICALLY PERFORMING DATA PROCESSING IN A DATA PIPELINE SYSTEM” of Palantir Technologies, Inc. discloses methods for automatically scheduling build jobs for derived datasets based on satisfying dependencies. It uses dataset dependency and timing metadata to build the data transformation pipeline.

EP 1 637 993 A2 titled “IMPACT ANALYSIS IN AN OBJECT MODEL” of Microsoft Corp. discloses methods for analyzing the relationship between objects in a data structure. A data transformation pipeline can be defined by a user by graphically describing and representing, via a graphical user interface, a desired data flow from sources to destinations through interconnected nodes.

US 2020/012739 A1 titled “METHOD, APPARATUS, AND COMPUTER-READABLE MEDIUM FOR DATA TRANSFORMATION PIPELINE OPTIMIZATION” of Informatica LLC discloses methods for optimizing the number of computation operations that are performed when passing data through a data transformation pipeline. A user can utilize a transformation descriptive language with a graphical user interface to instruct the data transformation engine on how to route data between transformation components in the data transformation engine.

As can be seen, the solutions proposed in the prior art are primarily based on the principle that the data transformation pipeline needs to be supplemented with metadata, or even has to be defined in its entirety by the end-user beforehand, to allow a programmatic handling of the desired data transformation workflow.

It is therefore a problem underlying the present disclosure to provide methods, systems and technical infrastructure which enables a structured handling of data engineering projects that at least partly overcomes the above-mentioned disadvantages of the prior art.

### SUMMARY

This problem is in one aspect of the invention solved by a computer-implemented method as defined in claim 1. The method may comprise a step of obtaining electronic data defining a plurality of data transformations. Each data transformation may define a step function and at least one of a set of input datasets and a set of output datasets. Typically, at least some, or even the majority, of the data transformations may define both a set of input datasets and a set of output datasets. However, neither inputs nor outputs are strictly required. For example, a transformation without inputs may only generate outputs, for example to simulate data, e.g., for machine learning in a transformation without input and then storing the result as output for further processing. An example of a transformation without output would be a self-designed notification service which checks the input data, e.g., for their last updated timestamp and then notifies a user.

Working with data typically requires starting with a set of input datasets which are then transformed into a set of output datasets. This is somewhat similar to cooking, where the cook starts from the raw ingredients and has produced a finished meal in the end. By defining data transformations in the manner as described above, it becomes possible to define (atomic) transformations including inputs and outputs independently from each other, i.e., in a modular fashion. Splitting the overall data transformation into smaller steps comes with several benefits, as it makes the whole transformation process more flexible. Such benefits include the possibility of reusing steps, easy extension of the step logic, parallel and distributed work, splitting the implementation and design of the (business) logic, as well as higher transparency for non-technical users.

The method may further comprise a step of automatically generating a data transformation graph based on the data transformations. The data transformation graph may link the data transformations by way of their input datasets and output datasets, such that the data transformation graph is executable at runtime. In this context, “automatically” may mean “programmatically”, i.e., without (substantial) user interaction, preferably without the need that a user indicates or explicitly prescribes the desired data flow between the individual steps, i.e. how to connect the steps to form the data transformation graph. In other words, in this aspect of the invention the data transformation graph, in particular the sequence of data transformations in the graph, can be generated based only on the definition of the data transformations, in particular their input and/or output datasets. In a preferred embodiment, no explicit information about an intended order, data flow, control flow and/or causal relationship between the data transformations is required, apart from their corresponding inputs and/or outputs. Accordingly, this aspect of the invention allows data engineers, data scientists, data analysts and other developers to implement individual steps of an overall data transformation which are then automatically turned into a linked pipeline. The technical benefits of this modular approach are manifold:
Readability: The modular approach enables well-structured analyses, allowing not only technical experts but even management personnel and deciders to understand the business logic on a high level before taking data driven decisions.
Efficient development and collaboration: The modular approach allows to define high-level analysis steps and to agree on the input and output datasets upfront. The steps can then be implemented in parallel by multiple developers.
Easier debugging and modification: Problems can be isolated, which speeds up debugging. In case the business logic needs to be modified only some steps need to be touched, which allows for quicker integration and testing of changes.

In another aspect of the invention, the data transformations may be defined using constructs of a programming language, preferably an object-oriented programming language. The step of generating the data transformation graph may comprise creating objects in the programming language to represent the data transformations. Preferably, all objects that constitute the data transformation graph are stored simultaneously in a working memory of a data processing apparatus. In other words, every environment participating in the development of the data transformation pipeline can hold the entire data transformation graph in memory due to its light-weight representation. This is particularly beneficial in distributed development scenarios because each compute instance can get awareness of the entire graph and the corresponding analysis pipeline. This is in contrast to traditional centralized approaches such as Luigi or Airflow, which use an external server which needs to be called via API. In addition, embodiments of the invention may need only one library to get started, instead of a larger setup as required, e.g., in Luigi or Airflow, which is beneficial in terms of portability.

The object-oriented programming language may be Python. The step function may be indicated by a Python decorator. Using Python may be a preferred choice due to its widespread use and powerful capabilities. However, the concepts and principles disclosed herein may be implemented in other programming languages.

In another aspect of the invention, the definition of a given data transformation may comprise at least one of a definition of the set of input datasets and/or the set of output datasets, in particular by way of one or more pointers to corresponding input and/or output storage locations, and computer code, or a reference to computer code, for defining the step function, in particular for defining how the step function transforms the input datasets into the output datasets. The data transformations may be defined in one or more computer files, such as in a dedicated computer file per data transformation or in a computer file for multiple data transformations. Having a structure where the transformations are manifested in code allows to use standard software versioning tools such as git to track changes. To this end, it may be sufficient to define the data transformations also in other types of data structures besides computer files, such as database tables or the like, or generally any type of data structure that allows to define computer code. Note that in the case of computer files, such files need not be static files but could be generated only when needed (“on the fly”).

In another aspect of the invention, the method may further comprise the step of executing the data transformation graph. The executing may comprise determining an execution environment for executing the data transformation graph. In particular, it may be determined whether the execution environment comprises a local data processing apparatus and/or a central and/or a remote data processing apparatus, in particular a cloud-based data processing apparatus. The executing may further comprise executing the plurality of data transformations in an order indicated by the data transformation graph. Note that the order of the data transformations in a data transformation graph is normally determined by the way datasets are produced by certain steps and consumed by others. The order between two steps is decisive when certain outputs of the first step are inputs to the second step.

Accordingly, this aspect of the invention provides an automatic discovery of the steps defined by the data transformation pipeline, although each one of possibly multiple individual developers may only have knowledge of the code associated with his or her data transformation. This helps to increase efficiency in development as there is a decoupling between the business logic and the actual implementation in code. The automatic step detection speeds up integrating new or removing existing data transformation steps without the need to restructure the code significantly.

The dynamic determining of the execution environment is also beneficial in terms of environment independency and makes the deployment to productive environments particularly easy. The fact that steps can be run on any machine increases the efficiency and speed of development and debugging, as developers can use an environment they are used to and are not bound to any preconfigured system. Deployment on a productive system does not require any additional effort.

Preferably, the step of executing the plurality of data transformations in an order indicated by the data transformation graph comprises determining an initial data transformation which does not depend on any other data transformation, and executing said initial data transformation. Further, the executing may comprise traversing the data transformation graph to determine a next data transformation which does not depend on any other data transformation, and executing said next data transformation, preferably until the last data transformation has been executed.

The executing of a given data transformation may comprise executing a pre-step function, if present, then executing the step function, and then executing a post-step function, if present. This ensures a proper execution of the data transformation pipeline in the given execution environment. The optional pre-step and/or post-step functions may be used to define execution environment-specific actions to be taken before and/or after executing the actual transformation step.

In another aspect of the invention, executing the step function may comprise on-demand loading of data associated with the input datasets, preferably from one or more input storage locations defined by the data transformation, and writing data associated with the output datasets, preferably to one or more output storage locations defined by the data transformation. Optionally, the loading may comprise downloading the data into a local execution environment.

In another aspect of the invention, a given data transformation may only be executed if an access privilege level of a user associated with the executing is sufficient. This ensures that no unauthorized personnel can execute a workflow.

In another aspect of the invention, the method is executed in a local execution environment. The step of obtaining electronic data defining a plurality of data transformations may comprise receiving user input defining the plurality of data transformations. The method may further comprise executing the data transformation graph in the local execution environment associated with the user. The method may further comprise receiving user input for publishing at least some of the data transformations to a central execution environment, in particular a production environment. This way, an efficient development workflow is provided that allows local development and testing as well as seamless transition to a production environment without the need to adapt the code.

In another aspect of the invention, the method is executed in a central execution environment, in particular a production environment. The step of obtaining electronic data defining a plurality of data transformations may comprise receiving the data transformations from one or more execution environments associated with one or more users. The method may further comprise executing the data transformation graph in the central execution environment.

In another aspect of the invention, the method may comprise the step of providing a definition of one or more execution environments. The definition may indicate at least one of at least one configuration variable of the execution environment, at least one data access method supported by the execution environment, a reference to a file system, one or more pre-step functions and/or post-step functions, and/or error handling functionality. Also provided is a computer program or a computer-readable medium having stored the computer program. The computer program may comprise instructions which, when executed by a computer, cause the computer to carry out any of the methods disclosed herein.

A data processing apparatus is also provided. The apparatus may comprise means for carrying out any of the methods disclosed herein.

A further embodiment of the invention is a data processing system. The system may comprise a plurality of local execution environments, each being executable on a data processing apparatus associated with a user, and configured for executing any of the methods disclosed herein. The system may further comprise a central execution environment, being executable on a data processing apparatus, in particular a cloud-based data processing apparatus, and configured for executing any of the methods disclosed herein.

### BRIEF DESCRIPTION OF THE DRAWINGS

The disclosure may be better understood by reference to the following drawings:

FIG. 1: An exemplary data transformation pipeline in accordance with embodiments of the invention.

FIG. 2: Three exemplary data transformations which, together, constitute the data transformation pipeline of FIG. 1 in accordance with embodiments of the invention.

FIG. 3: An exemplary file-based storage format for a data transformation project in accordance with embodiments of the invention.

FIG. 4: An exemplary execution flow when a data transformation pipeline is executed in accordance with embodiments of the invention.

### DESCRIPTION OF PREFERRED EMBODIMENTS

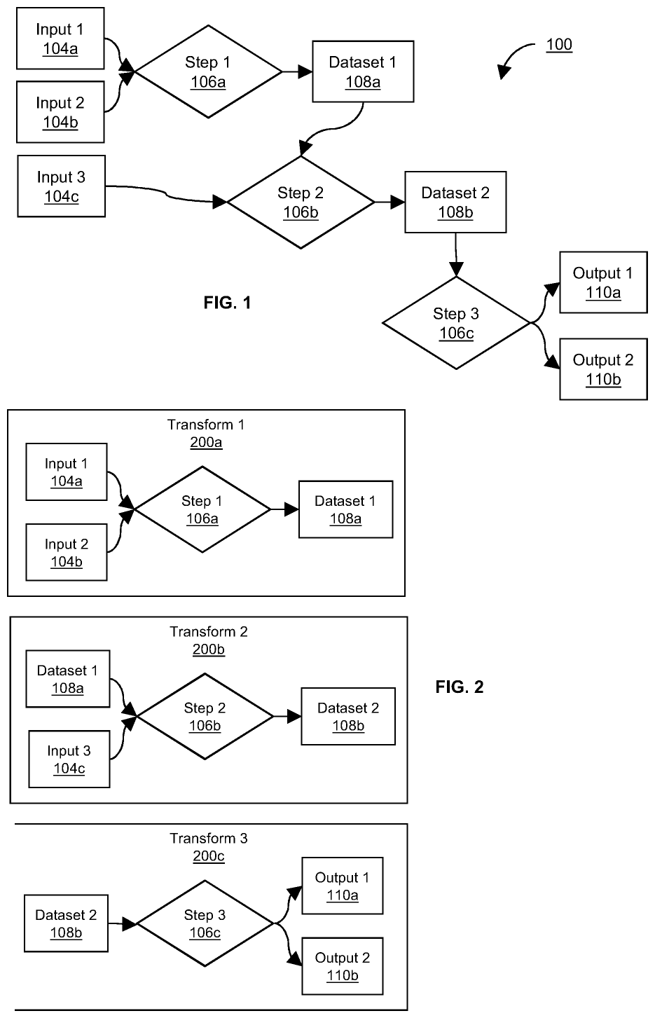

FIG. 1 shows an exemplary data transformation pipeline 100. The pipeline 100 takes as input three input datasets 104a, 104b and 104c and eventually produces two output datasets 110a and 110b by way of three steps 106a, 106b and 106c. As can be seen, a data transformation pipeline 100 can be conceptualized as a (directed) graph with nodes and edges. The nodes represent datasets and the edges represent transformation steps that consume or produce datasets.

FIG. 2 shows three exemplary data transformations 200 that, together, constitute the data transformation pipeline 100 of FIG. 1. As can be seen, the first transform 200a comprises a first step 106a which consumes two input datasets 104a and 104b and produces a dataset 108a. Note that the input datasets 104a and 104b are typically datasets just like the dataset 108a, but labelled “input datasets” in the present disclosure because they serve as the input of the overall pipeline 100. In FIG. 2 the dataset 108a is just labelled “dataset” although it is an “output dataset” from the perspective of step 106a as well as an “input dataset” from the perspective of the second step 106b also shown in FIG. 2. As one can see, said step 106b is part of a second transform 200b. Step 106b consumes the dataset 108a and another input 104c and produces a dataset 108b. Finally, FIG. 2 shows a third transform 200c, the step 106c of which consumes the dataset 108b and produces output datasets 110a and 110b. It is important to note that the step 106c need not be aware that its output datasets 110a and 110b are in fact the final outputs of the overall pipeline 100, as in the depicted example.

In the example of FIG. 2, each of the steps 106 contains user-defined code for the corresponding transformation 200. In a preferred embodiment, the user has access to all inputs and outputs, e.g., in a variable or other element of the used programming environment, while coding the step 106, ideally to all datasets 104, 108, 110 used in the pipeline 100. Certain embodiments of the invention provide a development environment in which the user is not even bound to use a specific framework such as a specific analytics engine, e.g., Apache Spark. Rather, the user may choose whatever framework is desired per step. In one embodiment, the environment is provided as a Python library such that only the following two requirements must be met:
The framework to be integrated can be operated from Python, e.g., via a software development kit (SDK) and/or a command line interface
The framework to be integrated supports the reading and writing of data

Because of this minimal set of compatibility requirements, certain embodiments of the environment may integrate frameworks such as, without limitation, Pandas, Numpy, Dask and Apache Spark.

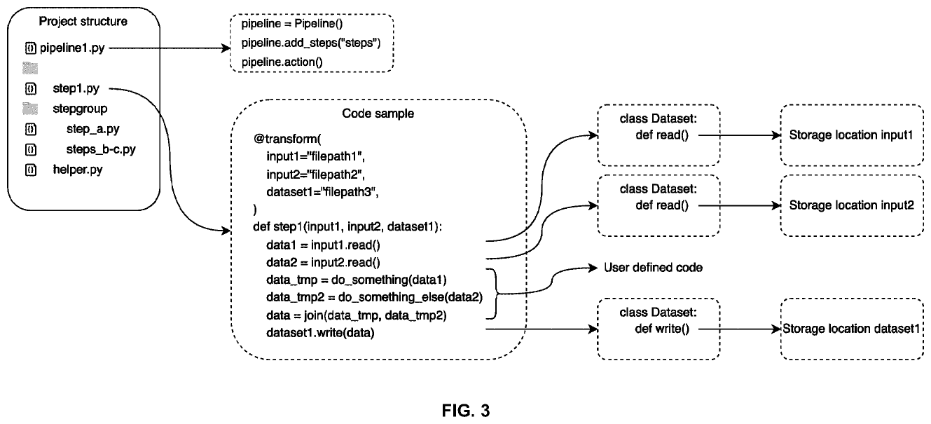

In the following, an exemplary project data structure will be described with reference to FIG. 3. In the illustrated example, the project comprises a pipeline file “pipeline1.py”. The pipeline file is typically set up once per project and then not touched further. The pipeline file in FIG. 3 defines a pipeline object (with “pipeline=Pipeline ( )”) and informs the pipeline where to look for steps (with “pipeline.add_steps (“steps”)”; note that the add_steps function takes as input a location indication where to find the steps, which is in this case the folder “steps” in FIG. 3; alternatively, it is also possible to add a step function directly, for example for testing purposes). The pipeline.action ( ) function shown in FIG. 3 serves for starting the pipeline.

This way, the pipeline file configures a command line interface of the pipeline. The command line allows the execution of the pipeline (e.g., completely or step-by-step) or the exporting of the pipeline into different formats, e.g., json, for further use in different tools, e.g., for display. To this end, the pipeline may be started with certain parameters such as, referring to the exemplary pipeline file in FIG. 3, “pipeline1.py-e”, where the “-e” triggers the exporting of the pipeline structure. Other command line interface parameters may be defined for other functions to control the execution of the pipeline during runtime, such as executing only a specific step within the pipeline, for example.

Furthermore, FIG. 3 shows a set of step files as part of the pipeline project (in the example labelled “step1.py”, “step_a.py” and “steps_b-c.py”) which may be organized in folders (see the folder “stepgroup”). Note that a single file can contain any number of steps (including no steps or multiple, as indicated by the filename “steps_b-c.py”).

FIG. 3 also illustrates the code included in the exemplary file “step1.py”. As can be seen, a definition of a step in code requires in the illustrated embodiment:
Definitions of the input and output datasets
User-defined code describing the actual data transformation from the inputs to the outputs

In the example of FIG. 3, the pipeline project also comprises an additional file “helper.py”, which is optional and may provide general helper functions. Examples include, without limitation, regular expressions to identify a pattern in different transformations or other string manipulations. Another non-limiting example includes functions for error handling, e.g., formatting an email before sending it via the environment.

A structure as illustrated in the embodiment of FIG. 3, where all transformations are manifested in code, allows the use of standard software versioning tools, such as git, to track changes. However, from a principal point of view it is not strictly necessary to provide the information explained above in the depicted project structure, or even in computer files. Rather, embodiments of the invention may use other means of defining the information, as long as it allows a definition of the data transformations as explained throughout the present disclosure.

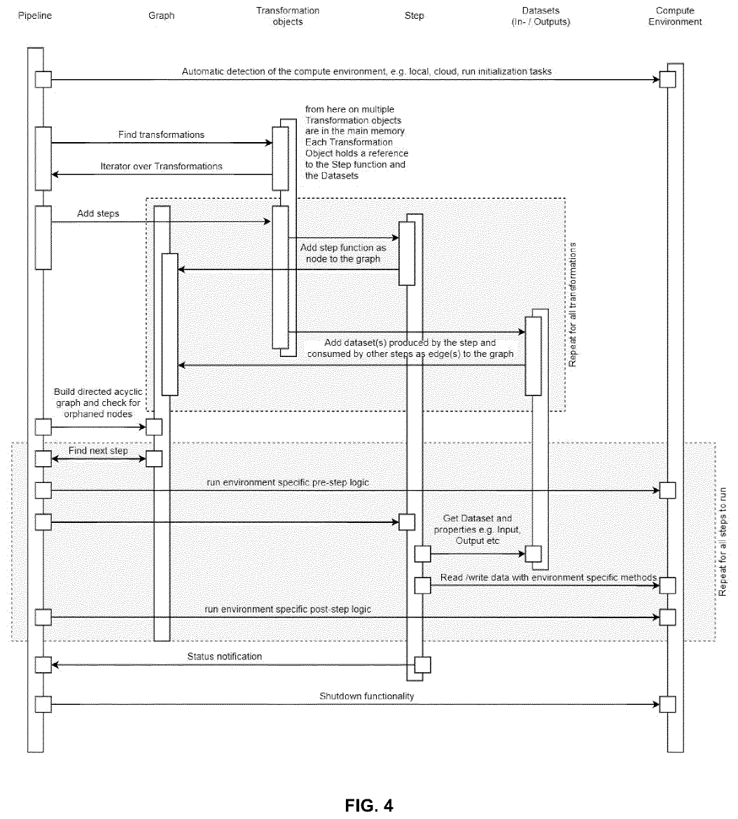

In the following, the execution of a data transformation pipeline 100 will be described with reference to FIG. 4. Executing a pipeline 100 generally means performing one transformation 200, i.e., its step 106, after the other until the end is reached. In an embodiment where the environment for generating and/or executing the pipeline 100 is provided in Python, typical requirements are:
A computing device with Python 3.6 or higher installed
A library implementing the principles described herein (“pydiap”)
All user-defined Python libraries need to execute the transformation code. However, it is not bound to a specific framework, such as Apache Spark, but supports any function that allows reading data from the provided storage location.

Turning now to FIG. 4, an execution of an exemplary data transformation pipeline will be described. Initially, the process starts the run of a pipeline, in the illustrated example by way of its command line interface, e.g., “python pipeline.py”.

Then, the process performs an automatic detection of the computing/execution environment it is running in to determine whether it is running, e.g., on a local device, a cloud-based environment, an on-premise location or an edge device. The determination may be performed using certain detectable characteristics of the environments, such as environment variables, IP addresses or other types of identifiers. The process may also run one or more initialization tasks associated with the determined execution environment. This may include, without limitation, checking whether all required (Python) packages are installed, installing missing packages, and/or creating the required folder structure where the data will be downloaded or stored to.

The process then moves on to find the transformations associated with the data transformation pipeline. In the embodiment of FIG. 4, this involves detecting all transformation objects stored as code in a directory structure (e.g., as explained in connection with FIG. 3). In the Python-based exemplary implementation according to embodiments of the invention, this involves importing all Python files in the given step directory (or a single step file if a single step file is only provided) as a Python module. After the import, all methods and objects are known on the module level. During the import, the transform decorator transforms the decorated function into a Transformation object. This object references the inputs, outputs and in case it gets called the transformation function is executed. Transforming the decorated functions into objects allows to efficiently filter for those objects in the module and add them to the pipeline.

Transformations may also be created “virtually”. For example, when many different datasets need the same transformation, e.g., for normalizing column labels (which is often needed to simplify joins later), one could arrange all inputs in the same transformation. However, this require that every time an input changes, all inputs need to be processed. An alternative is to automatically create transformation objects in a loop so that every input has its own transformation. To do this, it may not be necessary to write a separate file for every input, i.e., transformation, but only a loop. As a result, the individual transformations exist only in the working memory, but not as dedicated files.

At this stage of the process, multiple Transformation objects, preferably representing all data transformations that make up the data transformation pipeline, are in the main memory. Each Transformation object holds a reference to the step function and the input and output datasets. This has the technical benefit that every environment can hold the entire graph in memory due to the light-weight representation of the data transformation pipeline. This way, each compute instance can get awareness of the entire graph, respectively the analysis pipeline in contrast to traditional centralized approaches such as Luigi or Airflow, which use an external server which needs to be called via API. In addition, the process according to the described embodiment needs only one library to get started instead of a huge setup, such as Airflow or Luigi.

The process then moves on to connect the Transformation objects into a graph, thereby automatically generating the data transformation pipeline. Programmatically speaking, the process iterates through all transformations, adds the corresponding step function as node to the graph and adds dataset(s) produced by the step and consumed by other steps as edge(s) to the graph.

Once the process has iterated through all transformations, the process moves on to build a directed acyclic graph and checks for orphaned nodes. This may include checking that the graph does not contain any cycles. Orphaned nodes may occur, e.g., when a programmer renames the input datasets in the code and then the input datasets do not exist anymore. Embodiments of the invention may generate a warning message in such situations. A warning is preferred over e.g., an automated removing of orphaned nodes, because such orphaned nodes may be desired in certain situations, e.g., if the objective is to run multiple unrelated transformations in one pipeline instead of defining separate pipelines.

After the object graph has been built, the process moves on to executing the pipeline. The process determines a transformation that does not depend on any other transformation, i.e., all inputs required by the transformation in question have to be already computed, and executes it. In the example of FIG. 4, an optional pre-step function associated with the transformation is executed to run environment-specific pre-step logic, e.g., to set environment-specific settings. Then, the step function is executed.

A particularly memory-efficient way of executing a given step function is when data is loaded on demand from the user-defined, environment-specific storage location of the data. Outputs are written to the user-defined, environment-specific storage location of the output. Access control of the user running the pipeline may also be taken into account. An additional feature for local development may be the automatic data download in the local environment (in case access is granted). Of course, it will be understood that the described access control features is not mandatory for the described download feature. Then, an optional post-step function is executed, e.g., to inform the environment of any errors or to shut down the environment.

The process then traverses the graph by determining a next step that does not depend on any other step, i.e. that has no inputs that are not yet computed, and executes it, as already described above in association with the first step. Finally, an environment specific shutdown function is called, and the process of FIG. 4 ends.

In summary, embodiments of the invention provide a generic flow that can be run in any preconfigured environment. Preconfigured means in this context that the software is installed including all requirements coming from the transformations defined by the data engineers. This speeds up the data engineering process from two sides: On the one hand, data engineers can focus on implementing the business logic. On the other hand, a smooth transition between local development and production-ready analyses is made possible.

An execution environment in accordance with embodiments of the invention may be defined by the following, or at least a subset of the following, aspects:
Configuration variables: For example where to find the stored data, i.e., information about a storage account, networking information (e.g., proxies), switching on and off of features (e.g. branching of datasets).
Methods to access and write tabular data: As the storage location might be different in different environments, the environment may centrally take care of reading and/or writing data from/to the right directory. These methods may mainly do path translations.
A reference to a filesystem used to access data from a binary dataset: Here, the difference is that for a local environment different methods need to be used than for a cloud-based or spark-based filesystem. Filesystems in general provide a unique interface, e.g., filesystem.list_files ( ) lists the files, however, behind the scenes for a local filesystem this uses the standard methods to list data on a local disk, for a cloud based filesystem the REST API of the cloud based filesystem is used, for a spark based filesystem the corresponding methods from spark are used.
Pre-and post-step functions: These functions may be executed before and after each step, e.g. to make sure that the code is available or to trigger further actions, such as notifying a separate service, i.e. a backend service, that a step has finished successfully.
Error handling functionality: This function may be called in case an error happens and allows, e.g., to send an email or other message with error information to a list of recipients. This is especially useful for cases where an analysis runs unattended in a schedule.

In a typical workflow using embodiments of the invention, developers may define (atomic) transformation steps including inputs and outputs independently from each other. Each developer can run the pipeline independently on a local device. When running the pipeline via am embodiment of the invention, it creates the pipeline according to the flow described further above with reference to FIG. 4. After testing locally, developers can push their changes into the production environment where they run without any modifications (e.g., using a standard git merge flow).

What follows is a step-by-step process for setting up a computing environment according to a practical exemplary implementation of concepts of the invention, where the environment is provided as a Python module:
1. General setup of the compute environment
   a. Install python >3.6 including pip and git on your computer
   b. Clone the repository of the invention from a predefined location
   c. Run pip install from the base directory of the cloned raw software. This compiles the software and installs the requirements.
   d. (optional) if you want to use Spark install Spark and Hadoop on your computer
2. Data Engineering project
   a. Create a directory which will contain the project, e.g. “My_Project”
   b. Inside that project create a directory: “steps”
   c. Create a python file: “pipeline.py”, and add the sample code shown in FIG. 3
   d. Create as many python files containing the different steps, see also sample code in FIG. 3.
3. Access to data with different options:
   a. Copy the data to your local computer inside a_data (can be configured) directory. Data paths in your transformations are relative to that directory; or
   b. Store your data in a Azure Data Lake and provide your Username, Credentials (alternatively a web based login is also supported), Storage location in a.env file or as environment variables. When running the pipeline (or steps of it) the software will automatically download the data
4. Execution:
   a. Use “python pipeline.py--run” to run the full pipeline. Alternatively, the “python pipeline.py--help” can be used to see additional options like running a single step, a subset of steps or exporting

Given that the execution environment is set up and the code is available, then option 3b leads to an independence of where the execution environment is actually running. This can be on a local computer, a virtual machine or even a pod inside a kubernetes cluster.

Although embodiments of the invention have been described primarily with reference to Python, it shall be emphasized that Python is only one of many possible implementation choices, while most of the concepts and principles disclosed herein are equally applicable to any object-oriented programming language, or any programming language or computing platform for that matter, as will be apparent to the person skilled in the art. For example, the concepts and principles disclosed herein may be implemented in C, Java or R. Furthermore, it is possible to run SQL code, as far as the compute environment of the underlying system supports it.

In the following, some of the various advantageous aspects of embodiments of the invention are explained in more detail. It shall be noted that certain embodiments may combine some, all or certain subsets of these aspects:
Automatic detection of transformation steps and their order: Data Engineering teams can concentrate on the business logic and do not need to take care of connecting the individual steps. Steps do not need to contain boilerplate code to register themselves to a pipeline. An alternative would be to have a central file the contains references to all steps, which reduces flexibility and extendibility, especially in case of parallel editing of the same analysis/transformation.
Self-contained analysis repositories leading to portability to any system: A minimal set of requirements to run an analysis removes any vendor lock-in. Even multi-cloud setups become possible, allowing to store data in one cloud and to run the analysis in another cloud.
Automatic detection of globally configured compute environments allowing an easy scale-up from development to production environments: Data Engineers working on a pipeline can develop their transformations locally and they can run without any modifications on a production environment.
Free to use with any Python data engineering ecosystem: Individual transformations can leverage any tool including spark, pandas and numpy. Developers are free to choose the tool that is appropriate for the task (or that they know best, if multiple are possible). This increases the areas where the software can be used (plus it increases the satisfaction of developers).
Exporting functionality: A pipeline can be exported to a predefined JSON schema, which helps to flexibly integrate with other tools to, e.g., schedule analyses in production or display a transformation pipeline in a graphical way. This follows the approach which also Microservices follow: One tool should do only one thing.
Concentration on datasets instead of actions: Embodiments of the invention are designed such that they use datasets as a clear connection between different actions. One benefit is that datasets can be defined as an exchange object between two transformations easily and before implementation. This basically defines a unique contract between different transformation steps, similar to an API contract. A clear understanding of what to expect and what to deliver is defined.
No limitation on type/format of datasets: Data engineering and data science tasks may involve any data format one can think of. Embodiments of the invention distinguish between tabular and binary formats. Tabular formats may be everything that can be considered as a 2D array or a 2D table, i.e. parquet files. Binary formats may be everything else, e.g. images, movies, zips, pdfs etc. Having no limitation on the supported formats is particularly beneficial, as this increases the area in which embodiments of the invention can be used and information is contained everywhere and can thus be extracted here.
Automatic dataset download: Local development can be speed up when the data is automatically downloaded on demand and no manual action needs to be taken. This also helps other data engineers to support quicker, e.g., in case of debugging as they just need the source code of the transformations.
Incremental datasets: Embodiments of the invention support incremental reads and writes to a dataset. The typical use case relates to datasets that receive regular updates, e.g., via an external schedule such as plant or sales data. Such datasets can be processed incrementally, meaning that the business logic inside the transformation step is only applied to the change in the input and added to the output. This has the advantage that not the full dataset needs to be processed again which saves computing resources and time.
Profiles: Although embodiments of the invention support any data engineering ecosystem, some of embodiments may concentrate on Spark. Here, it is important to give data engineers the flexibility to define an appropriate spark profile when working on the transformation. A Spark profile contains, e.g., the number of cores, the amount of consumed memory, or other hardware-related parameters. However, profiles in embodiments of the invention are not bound to Spark, but can easily be extended to other tools, such as HTCondor.
Running a pipeline from a dataset to a dataset or all datasets downstream: This allows running only a subset of the transformations, which may be useful for debugging purposes or to schedule only parts of a larger pipeline that receive updates on a more often interval than others.
Running a single transformation step by name or file path: This allows to develop and debug individual transformations, thereby simplifying the life of data engineers.

In embodiments of the invention, the inventors have realized that a misconception in data engineering before the invention was the usage of so-called jupyter notebooks (in Azure: Synapse notebooks, in Google Colab etc.). While they can have their benefits, especially in terms of connecting display of data and code close to each other, thus being a good fit for prototyping, they also come with certain downsides: Versioning via standard software developer tools, such as git is not possible (all major cloud providers have their own developments). When scaling to productive workflows, oftentimes developers are hired to refactor the code and move it into a production environment, such as kubernetes. Extending a notebook with more and more cells leads at some point to a confusing situation. The cells also have always an order from top to bottom which means that data engineers are responsible for flattening a multi-branched graph, e.g., a tree-like structure, which again can easily lead to a confusing situation. Another prejudice often seen is that data engineering is a static operation: “You clean those datasets and then you join them and then you are done”. But this is only true for the moment. Typically, in reality requirements change quickly and need an easy extension of what already exists. Oftentimes, projects also need to be split into sub-projects, e.g., to improve maintainability and/or governance. Embodiments of the invention support this, as a transformation is considered as an atomic unit that can live anywhere.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Any computer device and system disclosed herein may be a local computer device (e.g., a personal computer, laptop, tablet computer or mobile phone) with one or more processors and one or more storage devices or may be a distributed computer system (e.g., a cloud computing system with one or more processors and one or more storage devices distributed at various locations, for example, at a local client and/or one or more remote server farms and/or data centers). A computer system may comprise any circuit or combination of circuits.

In one embodiment, the computer system may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA) or any other type of processor or processing circuit. Other types of circuits that may be included in the computer system may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system may also include a display device, one or more speakers, and a keyboard and/or controller, which can include a mouse, trackball, touch screen, voice-recognition device, or any other device that permits a system user to input information into and receive information from the computer system.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

1. A computer-implemented method with at least the following steps:
obtaining electronic data defining a plurality of data transformations (200), wherein each data transformation (200) defines a step function (106) and at least one of a set
of input datasets (104, 108) and a set of output datasets (108, 110); and
automatically generating a data transformation graph (100) based on the data transformations (200), wherein the data transformation graph (100) links the data transformations (200) by way of their input datasets (104, 108) and output datasets (108,110).

2. The method of claim 1, wherein the data transformations (200) are defined using constructs of a programming language;
wherein the step of generating the data transformation graph (100) comprises
creating objects in the programming language to represent the data transformations (200); and wherein, optionally, the programming language is Python, and the step function (106) is indicated by a Python decorator.

3. The method of claim 2, wherein all objects that constitute the data transformation graph (100) are stored simultaneously in a working memory of a data processing apparatus.

4. The method of claim 1, wherein the definition of a given data transformation (200) comprises at least one of:
a definition of the set of input datasets (104, 108) and/or the set of output datasets (108, 110), in particular by way of one or more pointers to corresponding input and/or output storage locations; and
computer code, or a reference to computer code, for defining the step function (106),
in particular for defining how the step function (106) transforms the input datasets (104, 108) into the output datasets (108, 110).

5. The method of claim 1, wherein the data transformations are defined in one or more computer files, such as in a dedicated computer file per data transformation (200) or in a computer file for multiple data transformations (200).

6. The method of claim 1, further comprising executing the data transformation graph (100), comprising:
determining an execution environment for executing the data transformation graph (100), in particular whether the execution environment comprises a local data processing apparatus and/or a central and/or remote, in particular cloud-based, data processing apparatus; and
executing the plurality of data transformations (200) in an order indicated by the data transformation graph (100);
wherein, the step of executing the plurality of data transformations (200) in an order indicated by the data transformation graph (100) comprises:
determining an initial data transformation (200) which does not depend on any other data transformation (200), and executing said initial data transformation (200); and traversing the data transformation graph (100) to determine a next data transformation (200) which does not depend on any other data transformation (200), and executing said next data transformation (200).

7. The method of claim 6, wherein executing a given data transformation (200) comprises:
executing a pre-step function, if present; executing the step function (106); and
executing a post-step function, if present.

8. The method of claim 7, wherein executing the step function (106) comprises:
on-demand loading of data associated with the input datasets (104, 108), from one or more input storage locations defined by the data transformation (200);
wherein, optionally, the loading comprises downloading the data into a local execution environment; and
writing data associated with the output datasets (108, 110), to one or more output storage locations defined by the data transformation (200).

9. The method of claim 6, wherein a given data transformation (200) is only executed if an access privilege level of a user associated with the executing is sufficient.

10. The method of claim 9, being executed in a local execution environment;
wherein the step of obtaining electronic data defining a plurality of data transformations (200) comprises receiving user input defining the plurality of data transformations (200); and
wherein the method further comprises:
executing the data transformation graph (100) in the local execution environment associated with the user; and
receiving user input for publishing at least some of the data transformations (200) to a central execution environment, in particular a production environment.

11. The method of claim 1, being executed in a central execution environment, in particular a production environment;
wherein the step of obtaining electronic data defining a plurality of data transformations (200) comprises receiving the data transformations (200) from one or
more execution environments associated with one or more users; and
wherein the method further comprises executing the data transformation graph (100) in the central execution environment.

12. The method of claim 1, further comprising providing a definition of one or more execution environments, the definition indicating at least one of:
at least one configuration variable of the execution environment;
at least one data access method supported by the execution environment; a reference to a file system;
one or more pre-step functions and/or post-step functions; and error handling functionality.

13. A computer program or a computer-readable medium having stored the computer program, the computer program comprising instructions which, when executed by a computer, cause the computer to carry out the method of claim 1.

14. A data processing apparatus comprising means for carrying out the method of claim 1.

15. A data processing system, comprising:
a plurality of local execution environments, each being executable on a data processing apparatus associated with a user, and configured for executing the method of claim 1; and
a central execution environment, being executable on a data processing apparatus, in particular a cloud-based data processing apparatus, and configured for executing the method of claim 1.
